(19) United States
(12) Patent Application Publication
(10) Pub. No.: US 2025/0083575 A1
(43) Pub. Date: Mar. 13, 2025

(54) ADJUSTMENT DEVICE FOR THE LONGITUDINAL ADJUSTMENT OF A VEHICLE SEAT AND ANCILLARY LOCKING DEVICE FOR THE SAME

(71) Applicant: Brose Fahrzeugteile SE & Co. Kommanditgesellschaft, Coburg, Coburg (DE)

(72) Inventor: Johannes Ultsch, Michelau i. OFr (DE)

(73) Assignee: Brose Fahrzeugteile SE & Co. Kommanditgesellschaft, Coburg, Coburg (DE)

(21) Appl. No.: 18/549,220

(22) PCT Filed: Mar. 11, 2022
(86) PCT No.: PCT/EP2022/056282

§ 371 Date: Sep. 6, 2023

(30) Foreign Application Priority Data
Mar. 15, 2021 (DE) 10 2021 106 279.9

(51) Int. Cl. B60N 2/07; B60N 2/08; B60N 2/42

(52) U.S. Cl. CPC B60N 2/073; B60N 2/0818; B60N 2/4214

(57) ABSTRACT

Disclosed is an adjustment device (103) for the adjustment of the position of a vehicle seat in a longitudinal direction, comprising at least one pair of rails comprising a first, fixed rail (3) and a second rail (5) movably guided thereto in a longitudinal direction (x), and an ancillary locking device (107) which comprises a plurality of first locking structures (24, 25) formed on or connected to the second rail (5), and a plurality of second locking structures (36, 37) formed corresponding to the first locking structures and formed on or connected to the first rail (3). The ancillary locking device is not active in a normal mode and, after introduction of forces in the event of a crash, causes an additional locking of the second rail (5) to the first rail (3) by positively locking of the first and second locking structures (24, 25; 36, 37) to one another.

In order to ensure a locking of the longitudinal position of the pair of seat rails in the event of a crash by the ancillary locking device in any longitudinal positions, the first and second locking structures (24, 25; 36, 37) are arranged on both sides of the respective pair of rails and at regular distances (a) from one another in the longitudinal direction (x), wherein the first locking structures (24a, 25a; 24b, 25b) or the second locking structures (36a, 37b; 36b, 37b) are arranged offset from one another in the longitudinal direction (x) on the two sides of the respective pair of rails.

### FIELD OF INVENTION

The invention relates in general to an adjustment device for the adjustment of the position of a vehicle seat in a longitudinal direction, in particular of a motor vehicle seat, and relates in particular to such an adjustment device with an ancillary locking device for the event of a crash, to an ancillary locking device for such an adjustment device as well as to a vehicle seat, in particular a motor vehicle seat.

### BACKGROUND OF INVENTION

In manual adjustment devices for the adjustment of the position of vehicle seats in a longitudinal direction, a main locking device is provided which is dimensioned in such a manner that, in the event of a crash, the pairs of seat rails do not peel open and the main locking device is not released. In the prior art, an ancillary locking device for the manual adjustment of the seat position in the longitudinal direction is also known which comprises a crash toothing or crash hooks that is disposed around one of the adjustment rails of a pair of seat rails for supporting the manual adjustment of the seat in the longitudinal direction. Here, a toothing is provided on both sides of the bottom rail or a bottom rail accessory, and a double-sided hole pattern corresponding to the toothing is provided on the upper rail or an upper rail accessory. In a normal state, the ancillary locking device is not active or effective. However, when force is applied in the event of a crash, the upper rail is lifted upwards and the respective toothing slides into the associated hole pattern. The resulting positive-fit locking between the hole pattern and the toothing can dissipate forces in the longitudinal direction of the vehicle and supports or reinforces the actual locking of the rails.

Such ancillary locking devices are used in particular in seat systems with higher crash loads, for example in belt-integrated seats or rear seats for two or more vehicle occupants.

However, a ‘tooth-on-web’ position of teeth of the toothing with recesses of the corresponding hole pattern may occur, which in any case delays and hinders the formation of the aforementioned positive-fit locking.

In the case of an electrically actuated longitudinal seat adjustment, the adjustment of the position in the longitudinal direction can stop in any position of travel, which further increases the probability of the occurrence of the aforementioned “tooth-on-web” position of teeth of the toothing with recesses of the corresponding hole pattern.

In manually operated adjustment devices for the adjustment of the position of a seat in a longitudinal direction, the main locking mechanism of the seat rails usually has a locking increment of less than or equal to 10 mm. An ancillary toothing for the aforementioned ancillary locking devices can therefore only be matched to this increment if the sheet thickness is small, which makes it difficult to comply with safety standards.

Additional ancillary locking mechanisms of the aforementioned type are disclosed, for example, in DE 100 46 203 A1, DE 36 14 457 A1, U.S. Pat. No. 2,019,299 816 A1 or U.S. Pat. No. 5,826,936 A.

### SUMMARY OF INVENTION

It is an object of the present invention to provide an adjustment device for the adjustment of the position of a vehicle seat in a longitudinal direction comprising a more efficient ancillary locking device having a simple structure. According to further aspects of the present invention, it is further intended to provide a corresponding ancillary locking device for such an adjustment device and a vehicle seat comprising such an adjustment device.

These problems are solved by an adjustment device for the adjustment of the position of a vehicle seat in a longitudinal direction with the features as claimed in claim 1, by an ancillary locking device for such an adjustment device with the features as claimed in claim 11, and by a vehicle seat with the features as claimed in claim 10. Further advantageous embodiments are the subject-matter of the dependent claims.

According to the present invention, there is provided an adjustment device for the adjustment of the position of a vehicle seat in a longitudinal direction, in particular of a motor vehicle seat, comprising at least one pair of rails comprising a first, fixed rail and a second rail movably guided relative to the first rail in a longitudinal direction, and an ancillary locking device comprising a plurality of first locking structures formed on or connected to the second, slidably guided rail, and a plurality of second locking structures formed corresponding to the first locking structures and formed on or connected to the first rail, and wherein the ancillary locking device is not active in a normal mode and, after the introduction of force in the event of a crash, causes an additional locking of the second rail to the first rail by positively locking of the first and second locking structures to one another.

According to the present invention, the first and second locking structures are arranged on both sides of the respective pair of rails and at regular distances from one another in the longitudinal direction, wherein the first locking structures or the second locking structures are arranged offset with respect to one other in the longitudinal direction on the two sides of the respective pair of rails.

If a “tooth-on-web” position should exist on a first side of the pair of seat rails in a particular position of the vehicle seat in the longitudinal direction, according to the present invention such a “tooth-on-web” position cannot exist in any case on the opposite second side of the pair of seat rails, so that locking of the position of the pair of seat rails in the longitudinal position is always ensured in the event of a crash.

This also allows the overall increment, i.e. the distance at which the locking structures on the two sides of the pair of seat rails are offset from one another in the longitudinal direction, to be reduced, which in turn allows a greater width of intermediate webs. Reinforcements can therefore also be designed with a higher sheet thickness.

According to a further embodiment, first locking structures or the second locking structures on the two sides of the respective pair of rails are arranged spaced apart from one another in the longitudinal direction in each case by a predetermined increment, the first locking structures or the second locking structures on the two sides of the respective pair of rails being arranged offset from one another in the longitudinal direction by an integer fraction n of the predetermined increment. The integer fraction can be used to suitably adjust the width of the intermediate webs of the hole patterns on the two sides of the pair of seat rails, thereby further modifying the crash safety characteristics.

According to a further embodiment, the following applies to the integer fraction n: n=2, which in particular enables identical widths of the intermediate webs of the hole patterns on the two sides of a pair of seat rails and thus a maximum crash safety of the longitudinal adjustment device.

According to a further embodiment, the first locking structures on the two sides of the respective pair of rails each form a hole pattern comprising a plurality of recesses, a plurality of intermediate webs separating the recesses, and a connecting web connecting the intermediate webs, or each form a toothing comprising a plurality of locking teeth and a plurality of tooth gaps arranged between the locking teeth, wherein the second locking structures on the two sides of the respective pair of rails each form a toothing comprising a plurality of locking teeth and a plurality of tooth gaps arranged between the locking teeth or each form a hole pattern comprising a plurality of recesses, a plurality of intermediate webs separating the recesses and a connecting web connecting the intermediate webs.

According to a further embodiment, the lengths of the recesses of the respective hole pattern are greater in the longitudinal direction than the lengths of the associated locking teeth of the respective toothing. This can further accelerate the formation of a positive-fit locking in the event of a crash, because the locking teeth can more rapidly enter the associated recesses of an associated hole pattern to form the positive-fit locking.

According to a further embodiment, the hole pattern is each formed as an embracing section which normally embraces or engages behind an opposite section with the associated teeth spaced apart in a direction perpendicular to the longitudinal direction. In this way, the mechanical strength under tensile load in the z-direction can be further increased and the crash safety can be adjusted according to requirements by suitable shaping of the opposing legs of the rail section.

According to a further embodiment, the hole pattern is formed respectively at the front end of lateral legs, which are formed on both sides and corresponding to a profile of connecting legs of the associated bottom rail.

According to a further embodiment, the lateral legs are connected to the second, slidably guided rail via a connecting plate. This connecting plate can be used for coupling with further components of a pair of seat rails.

According to a further embodiment, the first locking structures or the second locking structures are each formed on either side of an embracing section of the bottom rail with the associated upper rail. This enables an advantageously high level of crash safety because the embracing sections on both sides of a pair of seat rails represent sections with maximum stability. In this case, these embracing sections are expediently provided at diagonally opposite corner regions of the seat rail profile and are biased or pre-tensioned against each other due to the shape of the rail profiles and their material characteristics.

According to a further embodiment, the ancillary locking device may alternatively also be connected to a belt adapter of a safety belt system, wherein the first locking structures are connected to the belt adapter and, in the event of a crash, the positive locking of the first and second locking structures of the ancillary locking device to one another is effected after the introduction of force in the safety belt system. Thus, an ancillary locking device according to the present invention can also be used in integral seats.

According to a further aspect of the present invention, there is provided a vehicle seat, in particular a motor vehicle seat, comprising at least one adjustment device for the adjustment of the position of a vehicle seat in a longitudinal direction as set forth above.

According to a further aspect of the present invention, there is provided an ancillary locking device for an adjustment device for the adjustment of the position of a vehicle seat in a longitudinal direction, in particular of a motor vehicle seat, wherein the adjustment device comprises at least one pair of rails comprising a first, fixed rail and a second rail movably guided in a longitudinal direction relative to the first rail, wherein the ancillary locking device comprises a plurality of locking structures arranged at regular distances from each other in the longitudinal direction.

According to the invention, the locking structures are designed to be arranged on both sides of the respective pair of rails, the locking structures being arranged on the two opposite sides offset from each other in the longitudinal direction, as set forth above.

### OVERVIEW ON DRAWINGS

Hereinafter, the invention will be described in an exemplary manner and with reference to the accompanying figures, wherein:

FIG. 1 is a schematic view of a motor vehicle seat comprising an adjustment device for adjustment of a position in a longitudinal direction and an ancillary locking device according to the present invention;

FIGS. 2a and 2b are perspective plan views of the bottom rail of an adjustment device for adjustment of a position of a motor vehicle seat in a longitudinal direction including an ancillary locking device according to the present invention;

FIGS. 3a and 3b are bottom views of the bottom rail of an adjustment device for adjustment of a position of a motor vehicle seat in a longitudinal direction including an ancillary locking device according to FIGS. 2a and 2b; and

FIG. 4 is a bottom view of the bottom rail of an adjustment device for adjustment of a position in a longitudinal direction according to a further embodiment, wherein the ancillary locking device is not shown.

In the drawings, the same reference numerals relate to identical or essentially equivalent elements or groups of elements.

### DETAILED DESCRIPTION

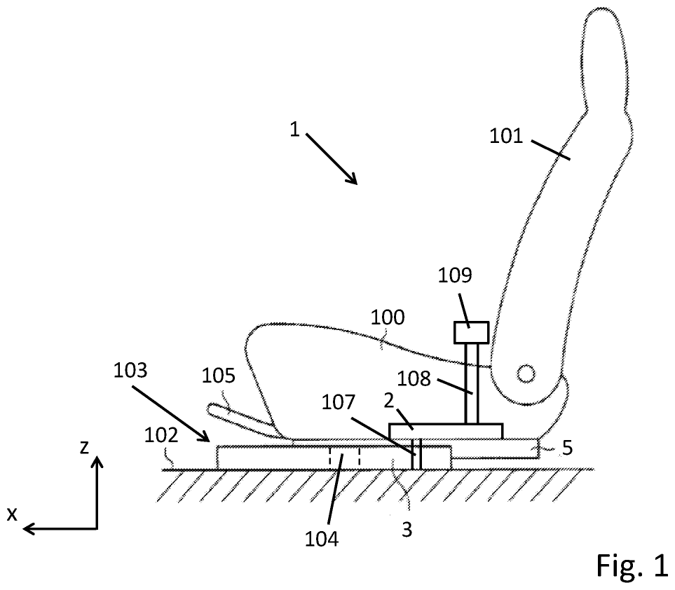

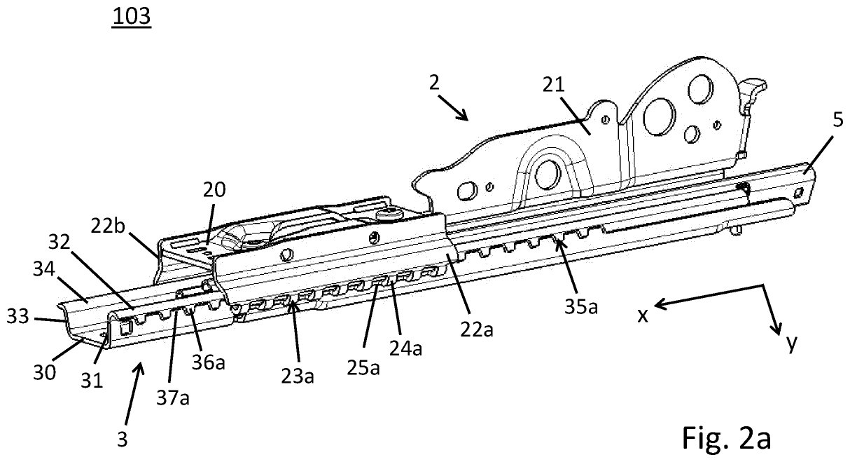

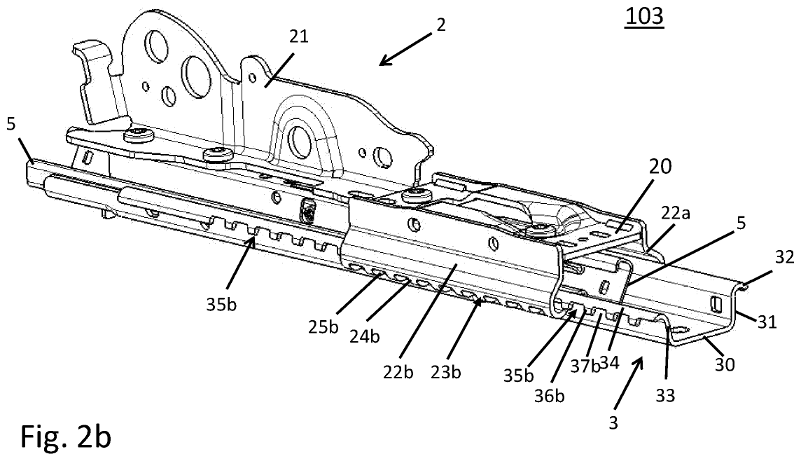

FIG. 1 shows in a schematic view a motor vehicle seat 1 comprising an adjustment device 103 for adjustment of a position in a longitudinal direction and an ancillary locking device according to the present invention. In the following description, the following terminology is used to define the spatial directions: a longitudinal direction x extends, in the case of a vehicle seat 1 installed in the vehicle, substantially horizontally and preferably parallel to a longitudinal direction of the vehicle which corresponds to the common direction of travel of the vehicle. A transverse direction (y; cf. FIG. 2a) running perpendicular to the longitudinal direction x is also horizontally oriented in the vehicle and runs parallel to a transverse direction of the vehicle. A vertical direction z runs perpendicular to the longitudinal direction x and perpendicular to the transverse direction y. In the case of a vehicle seat 1 installed in the vehicle, the vertical direction z runs parallel to the vertical axis of the vehicle. Indications of position and direction, such as front, rear, top and bottom, refer to a viewing direction of an occupant sitting on the vehicle seat in a normal sitting position, the vehicle seat 1 being installed in the vehicle, in a position of use suitable for passenger transport with the backrest 101 upright and oriented in the direction of travel as usual.

The vehicle seat 1 for a motor vehicle shown in FIG. 1 comprises a seat member 100 and a backrest 101 adjustable in its inclination relative to the seat member 100. The vehicle seat 1 is mounted on a longitudinal adjustment device 103 for adjustment of the position of the seat in the longitudinal direction, which comprises at least one pair of rails, including a first seat rail 5 (hereinafter referred to as the ‘upper rail’), in particular for connecting to a side part of a seat frame, and a second seat rail 3 (hereinafter referred to as the ‘bottom rail’), which is connected in particular in a fixed manner to a vehicle structure, for example to a vehicle base 102. The seat rails 3, 5 of the pair of seat rails can be displaced relative to one another in the longitudinal direction x.

In the case of a manually operated longitudinal adjustment device 103, a main locking device 104 is provided for securing the longitudinal position of the vehicle seat 1, which can be actuated by means of an operating lever 105. An ancillary locking device 107 is provided for additionally locking the upper rail 5 to the bottom rail 3. In a normal mode, the ancillary locking device 107 is not active (effective), so that the longitudinal position of the vehicle seat 1 can be adjusted unhindered by means of the longitudinal adjustment device 103. As a result of the application of force in the event of a crash, the upper rail 5 is pulled upwards (in z-direction) relative to the bottom rail 3, in particular at the rear end region of the upper rail 5. The relative movement as a result of the application of force in the event of a crash results in an additional locking of the upper rail 5 to the bottom rail 3 by positively locking of locking structures of the ancillary locking device 107 to one another, as described hereinafter in more detail.

In the case of a manually operated longitudinal adjustment device 103, the situation may arise where, shortly before a crash, the user of the seat has accidentally released the main locking device 104 in order to adjust the vehicle seat by displacement. In the event of a crash, the vehicle seat is then accelerated and even after releasing the locking lever, the main locking 104 cannot be restored quickly enough due to the high relative speed. The ancillary locking device 107 ensures a reliable locking of the upper rail 5 to the bottom rail 3.

The vehicle seat 1 may also be an integral seat provided with a belt adapter 2, wherein a belt buckle 109 of a safety belt system is connected to the belt adapter 2 via a connecting part 108, which is formed on or connected to the upper rail 5. In the event of a crash, a relative movement between the user of the seat and the vehicle seat 1 causes a tightening of the seat belt, which pulls the belt buckle 109 upward (in the z-direction) relative to the upper rail 5, causing an additional locking of the upper rail 5 to the bottom rail 3 by positively locking of locking structures of the ancillary locking device 107 to each other, as outlined hereinafter in more detail.

FIGS. 2a and 2b show in an exemplary manner the profile of a bottom rail 3, comprising a bottom 3, which is aligned in horizontal direction, for connecting to a fixed vehicle structure, two connecting legs 31, 33 projecting laterally and obliquely upwardly therefrom, and two folded lateral legs 32, 34 which embrace lateral legs of the upper rail 5 of corresponding shape in the known manner in embracing sections, for preventing a peeling-off of the pair of seat rails.

A first ancillary toothing 35a is formed on the first folded lateral leg 32, which comprises a plurality of first locking teeth 36a spaced apart from each other in the longitudinal direction x at regular intervals (hereinafter referred to as increment a), a tooth gap 37a being formed between each two successive first locking teeth 36a. A second ancillary toothing 35b is formed on the opposite second folded lateral leg 34, which comprises a plurality of second locking teeth 36b arranged spaced apart from each other at the same regular intervals (a) in the longitudinal direction x, a tooth gap 37b being formed between each two successive second locking teeth 36b.

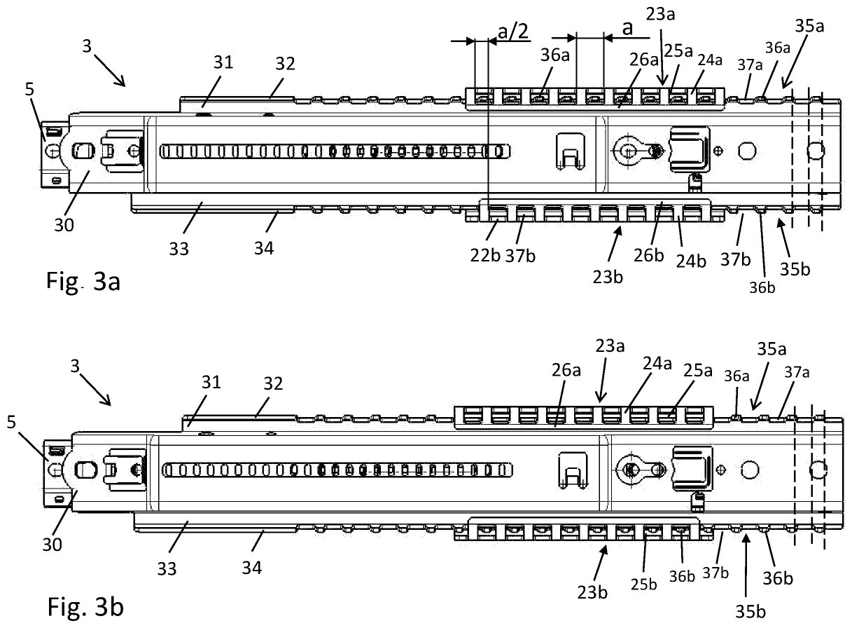

Further, an adapter 2 having an upright connecting web 21 and an upper connecting plate 20 is provided, which may be formed on the upper rail 5 or coupled or connected thereto. In this case, the lateral legs of the pair of rails of the upper and bottom rails 5, 3 are embraced by lateral legs 22a, 22b of corresponding shape which are connected to the upper connecting plate 20. At the front ends of each of the lateral legs 22a, 22b, a hole pattern 23a, 23b is formed corresponding to the associated ancillary toothing 35a, 35b. As can be concluded from FIGS. 3a and 3b, a respective hole pattern 23a, 23b includes a plurality of recesses 24a, 24b and a plurality of intermediate webs 24a, 24b separating the associated recesses 24a, 24b from each other. The front ends of the intermediate webs 24a, 24b are connected to each other by a connecting web 26a, 26b.

In a normal mode, the ancillary locking device formed in this way is not active (effective), i.e. the hole patterns 23a, 23b and associated ancillary toothing 35a, 35b are not in mutual engagement, so that the upper rail 5 can be freely displaced relative to the bottom rail 3 in the case of a mechanical longitudinal adjustment device after the main locking device has been released in order to adjust the longitudinal position of the seat, or can be displaced relative to the bottom rail 3 in the case of an electrically operated adjustment of the position of the seat in longitudinal direction by actuating an electric motor.

In the event of a crash, a relative movement between the user of the seat and the vehicle seat introduces a tensile force into the system acting in the z-direction, which, by raising the upper rail 5 relative to the bottom rail 3, causes positive engagement of the ancillary toothing 35a, 35b in the associated hole pattern 23a, 23b and thus an additional locking of the upper rail 5 to the bottom rail 3.

As can be seen from FIGS. 3a and 3b, the locking teeth 36a on a first side of the bottom rail 3 are not offset in the longitudinal direction x relative to the locking teeth 36b on the opposite second side of the bottom rail 3, that is, they are aligned in the y-direction, as indicated by the dashed lines in the right-hand part of the drawing.

As can be further concluded from FIGS. 3a and 3b, according to the present invention the two hole patterns 23a, 23b on the two sides of the pair of seat rails are arranged offset to each other in the longitudinal direction x, i.e. they are not aligned in the y-direction. In the exemplary embodiment shown in the drawings, this offset corresponds to one half of the increment a under which the recesses 25a, 25b are arranged spaced apart from each another in the longitudinal direction (x). According to the present invention, this ensures that in the event of a crash, if there should exist a “tooth-on-web” position on one side of the pair of seat rails in a certain longitudinal position, for example in the case of FIG. 3a of the second locking teeth 36b of the second ancillary toothing 35b with the recesses 25b of the associated second hole pattern 23b on the second side of the pair of seat rails, no such “tooth-on-web” position exists on the opposite first side of the pair of seat rails, i.e. then the first locking teeth 36a of the first ancillary toothing 35a can slide easily into the recesses 25a of the associated first hole pattern 23a on the opposite first side of the pair of seat rails and engage therein in a form-fitting manner.

Hence, according to the present invention an additional locking can be triggered more quickly and reliably, because according to the present invention an obstructive “tooth-on-web” position is prevented in any longitudinal position of the pair of seat rails, at least on one side.

In this context, the offset in the longitudinal direction (x) expediently corresponds to an integer fraction (n) of the increment a under which the locking teeth 36a, 36b are arranged spaced apart to each other in the longitudinal direction x on the two sides of the bottom rail 3. Preferably, the following applies to this integer fraction (n): n=2. The locking teeth 36a, 36b and tooth gaps 37a, 37b formed therebetween do not necessarily have to be of the same length in the longitudinal direction x. Moreover, the locking teeth 36a, 36b and the tooth gaps 37a, 37b formed therebetween may have different lengths on the two sides of the bottom rail, respectively, with the increment a preferably being identical on both sides of the bottom rail 3. As can be seen from FIGS. 3a and 3b, for example, the locking teeth 36a on the first side of the bottom rail 3 are formed slightly shorter than the locking teeth 36b on the opposite second side of the bottom rail 3, which applies correspondingly in reverse to the tooth gaps 37b on the second side of the bottom rail 3 and the tooth gaps 37a on the opposite first side of the bottom rail 3. As can be further seen from FIGS. 3a and 3b, the front and rear flanks of the locking teeth 36a, 36b are beveled to enable a better sliding of the locking teeth 36a, 36b into the recesses 25a, 5b of the associated hole pattern 23a, 23b in the event of a crash. This different design of the ancillary toothing 35a, 35b on the two sides of the pair of seat rails enables the ancillary locking device to be triggered even more quickly and reliably in accordance with the present invention.

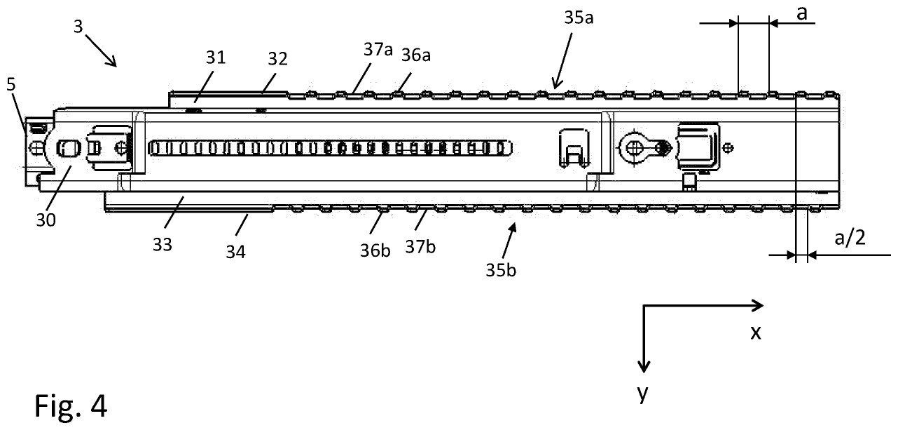

As will be readily apparent to those skilled in the art, instead of the aforementioned offset of the hole patterns, in a corresponding manner the ancillary toothing on the two sides of the pair of seat rails may also be arranged relative to each another offset in the x-direction, i.e. not aligned in the y-direction. An example of a bottom rail 3 designed in accordance with such a configuration is shown in FIG. 4 in a bottom view. In this embodiment, the associated hole patterns (not shown in FIG. 4) are correspondingly not offset relative to each other in the x-direction, i.e. they aligned in the y-direction.

While the above was based on the assumption that the hole patterns 23a, 23b are provided on the two lateral members 22a, 22b embracing the pair of seat rails and the ancillary toothing 35a, 35b are formed on the bottom rail, the hole patterns may also be formed on the bottom rail in a corresponding manner and the ancillary toothing may also be provided on the two lateral members embracing the pair of seat rails in a corresponding manner, i.e. the roles of components fixed to the upper rail and those fixed to the bottom rail may be interchanged.

In general, an ancillary locking device according to the present invention always enables an increased degree of safety in the event of a crash if vehicle seats with a relatively high weight are to be adjusted by means of a longitudinal adjustment device. This may be the case, for example, with vehicle seats that are equipped with numerous additional comfort features, which involves the installation of numerous, relatively heavy electric motors and actuators. Another area of application, due to their very heavy weight, are rear seat benches of motor vehicles, in particular multi-seat rear seat benches, the position of which in the longitudinal direction of the vehicle can be adjusted by means of at least one pair of seat rails.

### LIST OF REFERENCE NUMERALS

1 vehicle seat
2 adapter
3 bottom rail
5 upper rail
20 upper connecting plate
21 connecting web
22a first lateral leg
22b second lateral leg
23a first hole pattern
23b second hole pattern
24a intermediate web of first hole pattern
24b intermediate land of second hole pattern
25a recess of first hole pattern
25b recess of second hole pattern
26a first connecting web
26b second connecting web
30 bottom of bottom rail
31 first connecting leg projecting upward
32 first folded leg
33 second connecting leg projecting upward
34 second folded leg
35a first ancillary toothing
35b second ancillary toothing
36a locking tooth of first ancillary toothing
36b locking tooth of second ancillary toothing
37a tooth gap of first ancillary toothing
37b tooth gap of second ancillary toothing
100 seat member
101 backrest
102 vehicle base
103 longitudinal adjustment device
104 main locking device
105 operating lever
107 ancillary locking device
108 connecting part
109 belt buckle
x longitudinal direction of vehicle
y transverse direction of vehicle
z vertical direction
a increment of locking structures

1. An adjustment device (103) for adjustment of the position of a vehicle seat in a longitudinal direction, comprising:
at least one pair of rails comprising a first, fixed rail (3) and a second rail (5) movably guided in the longitudinal direction (x) relative to the first rail; and
an ancillary locking device (107); wherein
the ancillary locking device comprises a plurality of first locking structures (24, 25) formed on or connected to the second rail (5), and a plurality of second locking structures (36, 37) formed corresponding to the first locking structures and formed on or connected to the first rail (3), and
the ancillary locking device is not active in a normal mode and, after introduction of forces in the event of a crash, causes an additional locking of the second rail (5) to the first rail (3) by positively locking of the first and second locking structures (24, 25; 36, 37) to one another,
wherein the first and second locking structures (24, 25; 36, 37) are arranged on both sides of the respective pair of rails and at regular distances (a) from each other in the longitudinal direction (x), wherein
the first locking structures (24a, 25a; 24b, 25b) or the second locking structures (36a, 37b; 36b, 37b) are arranged offset with respect to one other in the longitudinal direction (x) on the two sides of the respective pair of rails.

2. The adjustment device as claimed in claim 1, wherein
the first locking structures (24a, 25a; 24b, 25b) or the second locking structures (36a, 37b; 36b, 37b) are each arranged spaced apart from each other in the longitudinal direction (x) by a predetermined increment (a) on the two sides of the respective pair of rails, and
the first locking structures (24a, 25a; 24b, 25b) or the second locking structures (36a, 37b; 36b, 37b) are each arranged offset from each other in the longitudinal direction (x) by an integer fraction n of the predetermined increment (a) on the two sides of the respective pair of rails.

3. The adjustment device as claimed in claim 2, wherein the following applies to the integer fraction n:
n=2.

4. The adjustment device as claimed in claim 1, wherein
the first locking structures on the two sides of the respective pair of rails each form a hole pattern (23) comprising a plurality of recesses (24), a plurality of intermediate webs (24) separating the recesses and a connecting web (26) connecting the intermediate webs (24), or a toothing (35) comprising a plurality of locking teeth (36) and a plurality of tooth gaps (37) arranged between the locking teeth (36), and wherein
the second locking structures each form, on the two sides of the respective pair of rails, a toothing (35) comprising a plurality of locking teeth (36) and a plurality of tooth gaps (37) arranged between the locking teeth (36), or a hole pattern (23) comprising a plurality of recesses (24), a plurality of intermediate webs (24) separating the recesses, and a connecting web (26) connecting the intermediate webs (24).

5. The adjustment device as claimed in claim 4, wherein the lengths of the recesses (24) of the respective hole pattern (23) in the longitudinal direction (x) are greater than the lengths of the associated locking teeth (36) of the respective toothing (35).

6. The adjustment device as claimed in claim 4, wherein the hole pattern (23) is formed in each case as an embracing section which, in a normal mode, embraces or grips behind an opposite section with the associated toothing (35) spaced apart in a direction perpendicular to the longitudinal direction (x).

7. The adjustment device as claimed in claim 6, wherein the hole pattern (23) is formed respectively at the front end of lateral legs (22), which are formed on both sides and corresponding to a profile of connecting legs (31, 33) of the associated bottom rail (3).

8. The adjustment device as claimed in claim 7, wherein the lateral legs (22) are connected to the second rail (5) via a connecting plate (20).

9. The adjustment device as claimed in claim 1, wherein the first locking structures (24a, 25a; 24b, 25b) or the second locking structures (36, 37) are each formed on both sides of an embracing section (34) of the bottom rail (3) with the associated upper rail (5).

10. The adjustment device as claimed in claim 1, wherein the ancillary locking device (107) is connected to a belt adapter (2) of a safety belt system, wherein the first locking structures (24, 25) are connected to the belt adapter (2) and, in the event of a crash, the positive locking of the first and second locking structures (24, 25; 36, 37) of the ancillary locking device to one another is effected after the introduction of a force in the safety belt system.

11. A vehicle seat, in particular a motor vehicle seat, comprising at least one adjustment device (103) for adjustment of the position of the vehicle seat in a longitudinal direction, said at least one adjustment device comprising:
at least one pair of rails comprising a first, fixed rail (3) and a second rail (5) movably guided in the longitudinal direction (x) relative to the first rail; and
an ancillary locking device (107); wherein
the ancillary locking device comprises a plurality of first locking structures (24, 25) formed on or connected to the second rail (5), and a plurality of second locking structures (36, 37) formed corresponding to the first locking structures and formed on or connected to the first rail (3), and
the ancillary locking device is not active in a normal mode and, after introduction of forces in the event of a crash, causes an additional locking of the second rail (5) to the first rail (3) by positively locking of the first and second locking structures (24, 25; 36, 37) to one another; wherein
the first and second locking structures (24, 25; 36, 37) are arranged on both sides of the respective pair of rails and at regular distances (a) from each other in the longitudinal direction (x), wherein
the first locking structures (24a, 25a; 24b, 25b) or the second locking structures (36a, 37b; 36b, 37b) are arranged offset with respect to one other in the longitudinal direction (x) on the two sides of the respective pair of rails.

12. An ancillary locking device (107) for an adjustment device (103) for adjustment of the position of a vehicle seat in a longitudinal direction, said adjustment device (103) comprising at least one pair of rails comprising a first, fixed rail (3) and a second rail (5) movably guided in the longitudinal direction (x) relative to the first rail; wherein
the ancillary locking device (23, 35) comprises a plurality of locking structures (24, 25; 36, 37) arranged at regular distances (a) from each other in the longitudinal direction (x)
wherein the locking structures (24, 25; 36, 37) are configured to be arranged on both sides of the respective pair of rails, wherein
the locking structures (24, 25; 36, 37) are arranged on the two opposite sides offset from each other in the longitudinal direction (x).

13. The vehicle seat as claimed in claim 11, wherein
the first locking structures (24a, 25a; 24b, 25b) or the second locking structures (36a, 37b; 36b, 37b) of the at least one adjustment device (103) are each arranged spaced apart from each other in the longitudinal direction (x) by a predetermined increment (a) on the two sides of the respective pair of rails, and
the first locking structures (24a, 25a; 24b, 25b) or the second locking structures (36a, 37b; 36b, 37b) of the at least one adjustment device (103) are each arranged offset from each other in the longitudinal direction (x) by an integer fraction n of the predetermined increment (a) on the two sides of the respective pair of rails.

14. The vehicle seat as claimed in claim 13, wherein the following applies to the integer fraction n of the at least one adjustment device (103):
n=2.

15. The vehicle seat as claimed in claim 11, wherein
the first locking structures on the two sides of the respective pair of rails of the at least one adjustment device (103) each form a hole pattern (23) comprising a plurality of recesses (24), a plurality of intermediate webs (24) separating the recesses and a connecting web (26) connecting the intermediate webs (24), or a toothing (35) comprising a plurality of locking teeth (36) and a plurality of tooth gaps (37) arranged between the locking teeth (36), and wherein
the second locking structures of the at least one adjustment device (103) each form, on the two sides of the respective pair of rails, a toothing (35) comprising a plurality of locking teeth (36) and a plurality of tooth gaps (37) arranged between the locking teeth (36), or a hole pattern (23) comprising a plurality of recesses (24), a plurality of intermediate webs (24) separating the recesses, and a connecting web (26) connecting the intermediate webs (24).

16. The vehicle seat as claimed in claim 15, wherein the lengths of the recesses (24) of the respective hole pattern (23) of the at least one adjustment device (103) in the longitudinal direction (x) are greater than the lengths of the associated locking teeth (36) of the respective toothing (35).

17. The vehicle seat as claimed in claim 15, wherein the hole pattern (23) of the at least one adjustment device (103) is formed in each case as an embracing section which, in the normal mode, embraces or grips behind an opposite section with the associated toothing (35) spaced apart in a direction perpendicular to the longitudinal direction (x).

18. The vehicle seat as claimed in claim 15, wherein the vehicle seat is a motor vehicle seat.

19. The ancillary locking device as claimed in claim 12, wherein
the first locking structures (24a, 25a; 24b, 25b) or the second locking structures (36a, 37b; 36b, 37b) are each arranged spaced apart from each other in the longitudinal direction (x) by a predetermined increment (a) on the two sides of the respective pair of rails, and
the first locking structures (24a, 25a; 24b, 25b) or the second locking structures (36a, 37b; 36b, 37b) are each arranged offset from each other in the longitudinal direction (x) by an integer fraction n of the predetermined increment (a) on the two sides of the respective pair of rails.

20. The ancillary locking device as claimed in claim 19, wherein the following applies to the integer fraction n:
n=2.
